(19) United States
(12) Patent Application Publication
(10) Pub. No.: US 2006/0185472 A1
(43) Pub. Date: Aug. 24, 2006

(54) Boosting adaptor for jack

(75) Inventors: Ting-Yin Chiu, Taichung City (TW); Wen-Tsung Hsu, Taipei City (TW)

Correspondence Address: BACON & THOMAS, PLLC, 625 SLATERS LANE, FOURTH FLOOR, ALEXANDRIA, VA, 22314, US

(73) Assignee: INFINITE ELECTRONICS INC., TAICHUNG CITY (TW)

(21) Appl. No.: 11/062,799

(22) Filed: Feb. 23, 2005

(51) Int. Cl. F16H 35/00

(52) U.S. Cl. 74/640

(57) ABSTRACT

A boosting adaptor for a jack is comprised of a housing, a power input member received in the housing for rotation driven by an external input power, a boosting gear assembly connected with the power input member and having a plurality of gears and rotary shafts for running driven by the power input member and for boosting the input power, and a power output member connected with the boosting gear assembly for connection with the jack and for outputting the boosted input power to the jack. Accordingly, while in cooperative operation with a jack, the boosting adaptor not only enables the laborsaving operation of the jack but also can be connected with an electric tool to enable the convenient operation of the jack.

### BACKGROUND OF THE INVENTION

1. Field of the Invention

The present invention relates generally to jacks for jacking up cars, and more particularly, to a boosting adaptor for a jack.

2. Description of the Related Art

A conventional jack, as shown in FIG. 9, is usually operated like that a screwdriver 75 or a rod-like member is inserted into a rotatable joint 72 of a jack 71 and then the screwdriver 75 is manually turned to drive the jack 71 to jack up a car.

However, such manual operation is obviously slow and laborsome because the user has to not only keep turning the screwdriver 75 but also prevent the screwdriver 75 from disengagement from the rotatable joint 72, prevent the fingers from injury incurred by rubbing the ground carelessly during the course of doing the turning of the screwdriver 75 hard, and crouch to do the job. In addition, while the car has been raised by the jack 71, the user has to make greater strength to keep operating the jack to jack up the car. For the common users, such operation is laborsome and inconvenient; especially for the female users who are generally weak in strength, such operation brings much trouble and toughness to them.

### SUMMARY OF THE INVENTION

The primary objective of the present invention is to provide a boosting adaptor, which enables the user to operate the jack with less strength and enables the operation of the jack to be laborsaving.

The secondary objective of the present invention is to provide a boosting adaptor, which is compatible with any commercially available electric screwdriver to enable the user to operate the jack conveniently by the electric screwdriver.

The foregoing objectives of the present invention are attained by the boosting adaptor, which is comprised of a housing, a power input member, a boosting gear assembly, and a power output member. The housing includes an input hole formed at an end thereof, an output hole formed at the other end thereof, and two holding members extending outwards for a predetermined length respectively from upper and lower sides of the input hole. The power input member is connected with the boosting gear assembly and located corresponding to the input hole, for rotation driven by an external input power. The boosting gear assembly is received in the housing for running driven by the power input member and for boosting the input power, including a plurality of gears and rotary shafts in cooperation with the gears. The power output member is connected with the boosting gear assembly for outputting the input power boosted by the boosting gear assembly, having at least one flat slot formed at an external end thereof. Accordingly, while in cooperative operation with a jack, the boosting adaptor not only enables the laborsaving operation of the jack but also can be connected with an electric tool to enable the convenient operation of the jack.

### BRIEF DESCRIPTION OF THE DRAWINGS

FIG. 1 is a partially exploded view of a first preferred embodiment of the present invention.

FIG. 2 is another partially exploded view of the first preferred embodiment of the present invention.

FIG. 3 is an exploded view of the boosting gear assembly in accordance with the first preferred embodiment of the present invention.

FIG. 4 is similar to FIG. 3, but viewing from another side.

FIG. 5 is a schematic view of the first preferred embodiment of the present invention in cooperative operation with a jack.

FIG. 6 is a schematic view of the first preferred embodiment of the present invention in cooperative operation with the jack and an electric screwdriver.

FIG. 7 is a partially exploded view of a second preferred embodiment of the present invention.

FIG. 8 is similar to FIG. 7, but viewing from another side.

FIG. 9 shows a conventional jack in cooperation with a screwdriver for operation.

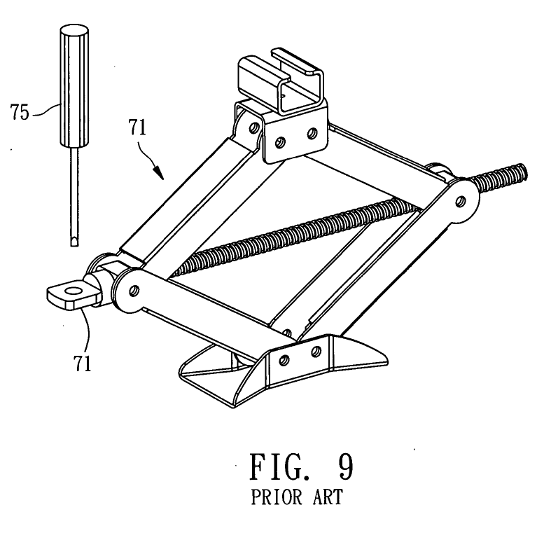

### DETAILED DESCRIPTION OF PREFERRED EMBODIMENTS

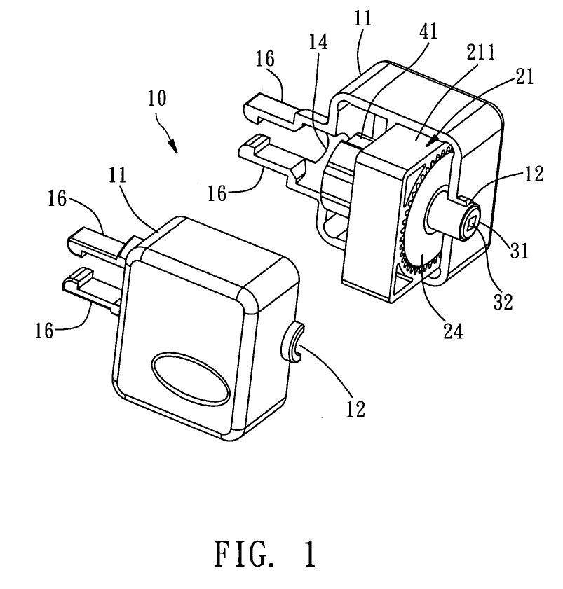

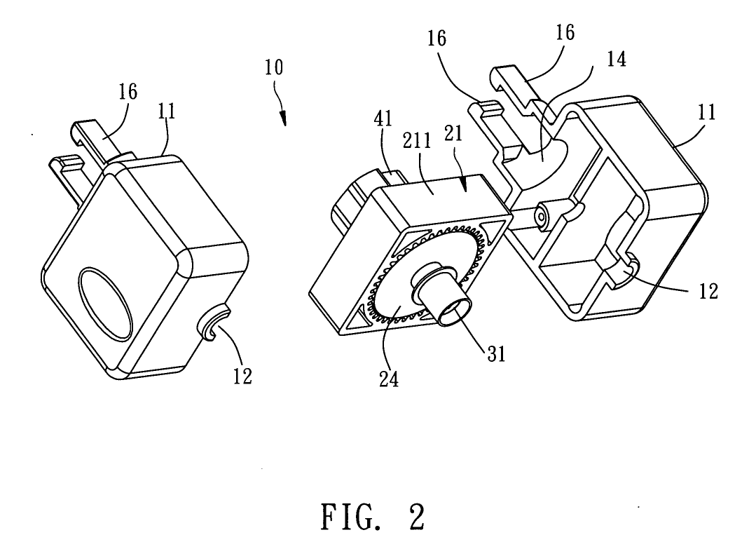

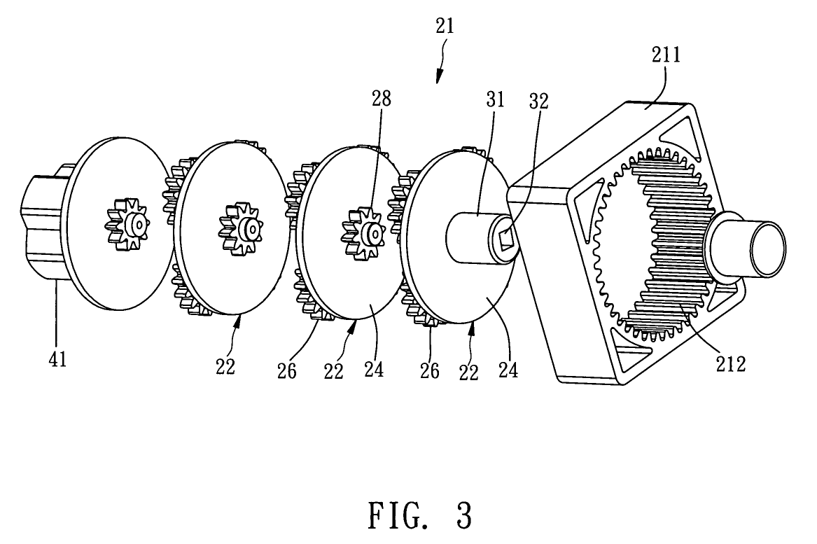

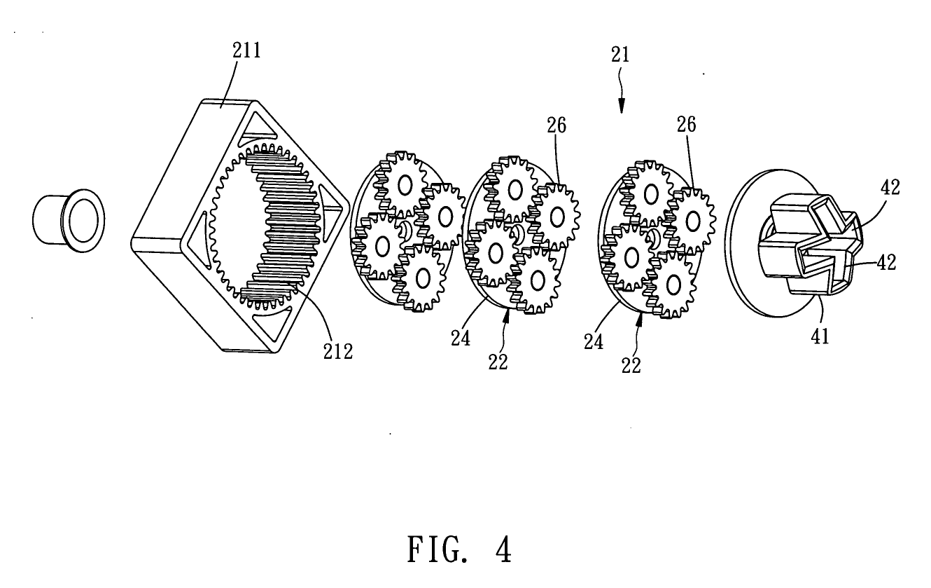

Referring to FIGS. 1-4, a boosting adaptor 10 constructed according to a first preferred embodiment of the present invention for a jack is comprised of a housing 11, a power input member 31, a boosting gear assembly 21, and a power output member 41.

The housing 11 includes an input hole 12 formed at an end thereof, an output hole formed at the other end thereof, and two holding members 16 extending outwards for a predetermined length respectively from upper and lower sides of the output hole 14.

The boosting gear assembly 21 is received in the housing 11, including an internally-toothed member 211 and three planetary gear sets 22. The internally-toothed member 211 has an annularly-toothed sidewall 212, which is comprised of a plurality of teeth annularly arranged at an inner periphery thereof. The three planetary gear sets 22 are mounted in the internally-toothed member 211, each including a circular plate 24 and four planetary gears 26, wherein each of two of the planetary gear sets 22 closest to the internally-toothed member 211 includes a pinion gear 28. The four planetary gears 26 are located on one side of each circular plate 24 and arranged around an axis of each circular plate 24, engaging the annularly-toothed sidewall 212. Each of the pinion gears 28 is located on the other side of the circular plate 24 on its axis, engaging the planetary gears 26 of the adjacent circular plate 24.

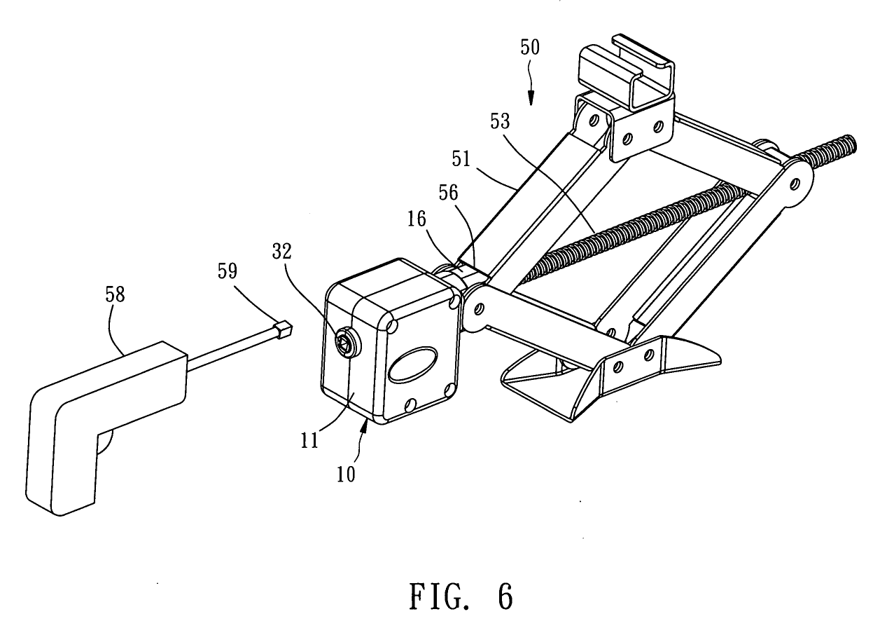

The power input member 31 is connected with the circular plate 24 closest to the input hole 12, having a rectangular socket 32 formed at an external end of the power input member 31 for connection and cooperation with a rectangular tool bit of an electric screwdriver 58 as shown in FIG. 6. The power input member 31 is located corresponding to the input hole 12 for rotation driven by an external input power to further drive the boosting gear assembly 21 to run, and then the boosting gear assembly 21 runs to boost the input power and transmit it to the power output member 41.

The power output member 41 is mounted corresponding to the output hole 14, including a pinion gear 28 and two flat slots 42, for outputting the boosted power. The pinion 28 engages the planetary gears 26 closest to the input hole 14. The two flat slots 42 are formed at an external end of the power output member 41 and arranged crosswise.

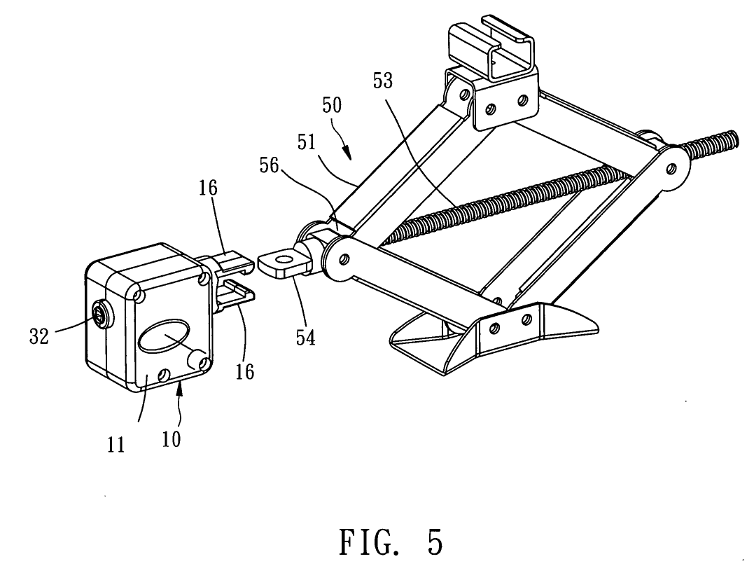

Referring to FIGS. 1-6, during the operation, the boosting adaptor 10 of the present invention is connected and cooperated with a jack 50, which is comprised of a linkage 51, a screw rod 53, a flat rotatable joint 54 formed at an external end of the screw rod 53, and two holding holes 56 formed between the linkage 51 and the screw rod 53.

First, insert the two holding members 16 into the two holding holes 56 and then sleeve one of the flat slots 42 of the power output member 41 onto the rotatable joint 54 of the jack 50. Next, hold an electric screwdriver 58, insert its rectangular tool bit 59 into the rectangular socket 32 of the power input member 31, and then activate the screwdriver 58 to drive the power input member 31 for rotation together with the rectangular too bit 59; meanwhile, the moment of force for the rotational power of the input member 31 is boosted by the boosting gear assembly 21 to drive the power output member 41 to rotate. Finally, the power output member 41 drives the rotatable joint 54 to rotate to further drive the jack 50 to lift and lower. Since the two holding members 16 are inserted into the two holding holes 56, the housing 11 can be securely held on the jack 50 without rotation driven by the rotational power. Further, the moment of force of the rotational power is boosted by the boosting gear assembly 58 to enable the user to employ the electric screwdriver 58, which is low-cost and low-torsion, for lifting and lowering the operation of the jack 50.

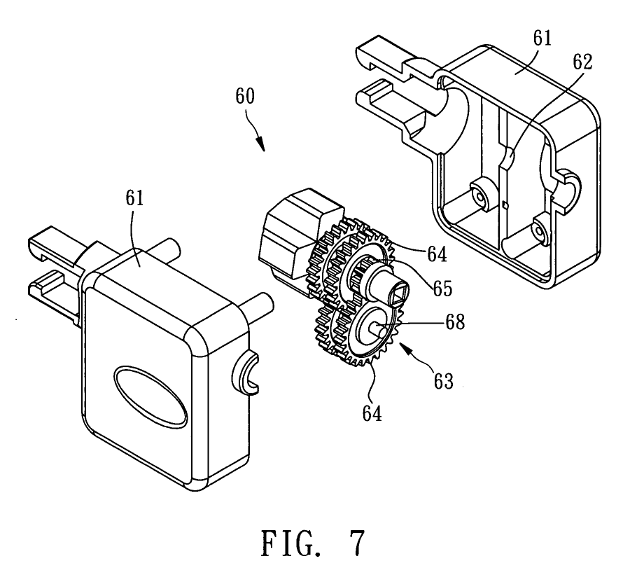

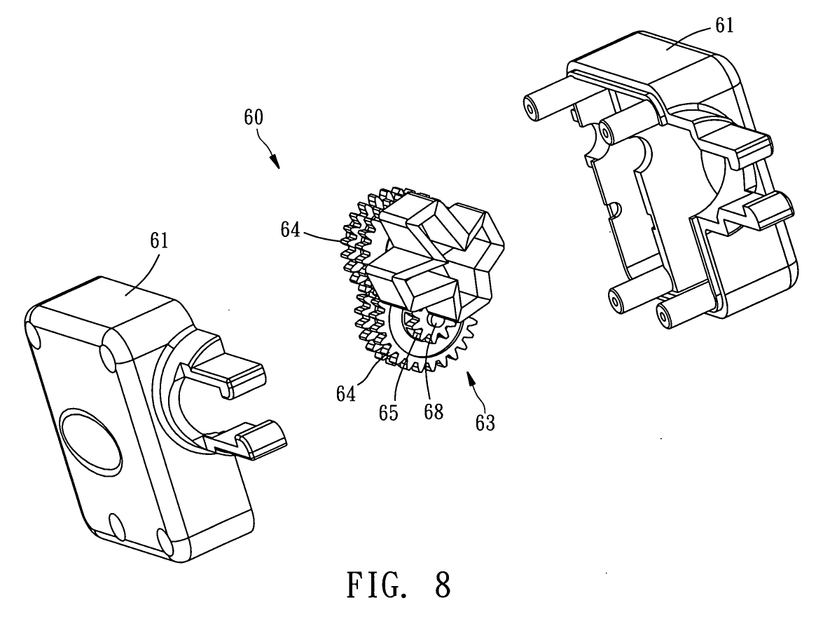

Referring to FIGS. 7 and 8, the boosting adaptor 60 constructed according to a second preferred embodiment of the present invention is similar to the first preferred embodiment but having difference as recited below.

The boosting gear assembly 63 includes a plurality of bull gears 64 and pinion gears 65 about different axes, and a plurality of rotary shafts 68 in cooperation with the bull gears 64 and pinion gears 65. The rotary shafts 68 are stationarily rotatably mounted in the axial holes 62. The bull and pinion gears 64 and 65 are engaged with one another to boost the moment of force of the rational power. The housing 61 includes a plurality of axial holes 62 therein for receiving the rotary shafts 68.

The operation of the boosting adaptor 60 of the second preferred embodiment is identical to that of the boosting adaptor 10 of the first preferred embodiment so that no further recitation is necessary.

It is to be noted that the rectangular socket 32 of the power input member 31 for cooperation with the tool bit of the electric screwdriver is not limited to the rectangular shape, that is, the hole of the power input member 31 can alternatively be other shapes for cooperation with the tool bits of other kinds of electrical screwdrivers.

In conclusion, the present invention has following advantages.
1. It is much laborsaving that the user can hold an electric screwdriver to operate a jack with less not great strength by the present invention.
2. It is much convenient that the user can hold an electric screwdriver to operate a jack by means of the present invention without manual turning.
3. It is much safe that the user can hold an electric screwdriver to operate a jack by the present invention without worrying about whether any injury of the hand will be caused by rubbing the ground during the operation.

What is claimed is:

1. A boosting adaptor for a jack, comprising:
a housing having an input hole formed at an end thereof, an output hole formed at the other end thereof, and two holding members extending outwards for a length from upper and lower sides of said output hole;
a power input member located corresponding to said input hole for rotation driven by an external input power;
a boosting gear assembly connected with said power input member and received in said housing and having a plurality of gears and rotary shafts in cooperation with said gears, for running driven by said power input member and for boosting said input power; and
a power output member connected with said boosting gear assembly and located corresponding to said output hole and having at least one flat slot at an external end thereof, for outputting the boosted input power.

2. The boosting adaptor as defined in claim 1, wherein said power input member comprises a rectangular socket formed at an external end thereof.

3. The boosting adaptor as defined in claim 1, wherein said power output member comprises two of said flat slots arranged crosswise.

4. The boosting adaptor as defined in claim 1, wherein said boosting gear assembly comprises an internally-toothed member and at least one planetary gear set, said internally-tooth member having an annularly-tooth sidewall formed at its inner periphery, said planetary gear set having a circular plate and a plurality of planetary gears, said planetary gears being located around an axis of said circular and engaging said annularly-tooth sidewall; said power output member further comprises a pinion gear engaging said planetary gears.

5. The boosting adaptor as defined in claim 1, wherein said gears of said boosting gear assembly are bull and pinion gears about different axes; said rotary shafts are stationarily rotatably mounted in said housing.
